(19) United States
(12) Patent Application Publication
(10) Pub. No.: US 2007/0015450 A1
(43) Pub. Date: Jan. 18, 2007

(54) MOLDED PLASTIC VENTING ASSEMBLY

(76) Inventors: Randall A. Bickel, Edwardsburg, MI (US); Suzanne C. Ritter, Edwardsburg, MI (US); Patrick J. Sapikowski, Elkhart, IN (US); James A. Welz, Goshen, IN (US); Robert J. Luter II, Elkhart, IN (US); Bryan S. Thursby, Elkhart, IN (US)

Correspondence Address: CALFEE HALTER & GRISWOLD, LLP, 800 SUPERIOR AVENUE, SUITE 1400, CLEVELAND, OH, 44114, US

(21) Appl. No.: 11/424,260

(22) Filed: Jun. 15, 2006

Related U.S. Application Data
(60) Provisional application No. 60/690,596, filed on Jun. 15, 2005.

(51) Int. Cl. B60H 1/00

(52) U.S. Cl. 454/69

(57) ABSTRACT

A venting assembly having modular components that can be connected together without use of external fasteners is disclosed. The modular components are capable of easily being attached to and detached from adjacent modular components, enabling individual modular components to be replaced or added into the assembly without replacing adjacent components.

### CROSS REFERENCE TO RELATED APPLICATION

This application claims priority to, and the benefit under 35 U.S.C. §119(e) of, U.S. Provisional Application 60/690,596 filed Jun. 15, 2005, titled MOLDED PLASTIC VENT, which application is hereby incorporated by reference in its entirety.

### BACKGROUND

Structures, especially enclosed structures, often have need to vent the interior of the structure. This can be to recirculate air, provide cooling, etc. This is especially true for structures in which there are people. These structures include stationary structures, such as buildings, or non-stationary structures, such as vehicles or trailers. Vents/venting assemblies are conventionally provided in such structures to provide the desired venting.

Conventional vents are attached to structures in a more or less permanent manner using conventional fasteners, such as nuts/bolts or other mechanical fasteners. These fasteners add cost to the vents and the installation, and result in additional components necessary for the installation of the vents, which provides additional opportunity for components to become lost or misplaced.

Conventional vents may be provided with one or more features, such as internal fans, screens, etc. These features are generally provided via permanent attachment to the vent assembly. For example, a vent having an electrically-controlled vent fan will have the fan, motor and controller permanently attached to the vent assembly. If these features are installed in a non-permanent manner, external fasteners are used, adding complexity to the venting assembly by the inclusion of additional parts. Moreover, removal of these features requires tools and is not easily accomplished.

If a user desires to have a vent with different or additional features than the installed vent, it is generally necessary to remove the entire vent assembly and replace it with a vent assembly having the desired features. For example, the purchaser of a recreational vehicle may desire to have a roof vent with features other than the features provided in the factory-installed roof vent. These features can be functional features, such as a fan and motor, or aesthetic features, such as a different color for a garnish or a screen frame housing.

### SUMMARY

The present invention is directed to a venting assembly for use in a recreational vehicle, enclosed trailer, enclosed shed, or any other structure, especially an enclosed structure, in which venting is desired. The venting assembly includes a plurality of modular components. Each of the modular components is capable of engagement with an adjacent modular component without the need for external fastening elements, such as by snap fit. This enables the individual modular components to be replaced or added into the venting assembly without replacing the entire assembly or adjacent components.

In one embodiment of the present invention, a vent for use in a recreational vehicle has a frame for installation in the top of the vehicle. The frame has a periphery and an open area radially inwardly of the periphery. A flange extends peripherally outwardly from the frame and is capable of contacting the top of the vehicle.

The flange seal is integral with the flange and is capable of establishing a seal between the flange and the top of the vehicle. A cover is hingedly attached to the frame without external fasteners, such as by snap fit, and is capable of covering the open area to substantially prevent the flow of air through the open area into the vehicle. The cover is further capable of being displaced to uncover the open area to allow flow of air through the open area into the vehicle.

A removable screen is connected to the frame and substantially covers the open area. The screen includes a screen frame housing capable of engaging the frame via a snap fit without external fastening elements, a screen frame capable of engaging the screen frame housing via a snap fit without external fastening elements, and a mesh portion secured by the screen frame. The frame, flange, cover, screen frame housing, and screen frame are constructed primarily of molded plastic.

### DESCRIPTION OF THE DRAWINGS

FIG. 1 is an exploded perspective view of an exemplary embodiment of the present invention;

FIG. 2 is an exploded perspective view of an exemplary embodiment of the present invention;

FIG. 3A is a top perspective view of an exemplary embodiment of a venting assembly of the present invention;

FIG. 3B is a bottom perspective view of the exemplary embodiment of FIG. 1A;

FIG. 3C is an elevational view of the exemplary embodiment of FIG. 1A;

FIG. 3D is a bottom view of the the exemplary embodiment of FIG. 1A;

FIG. 3E is an elevational view of the exemplary embodiment of FIG. 1A;

FIG. 3F is a side view of the exemplary embodiment of FIG. 1D;

FIG. 4A is a top perspective view of an exemplary embodiment of a venting assembly of the present invention;

FIG. 4B is a bottom perspective view of the exemplary embodiment of FIG. 1A;

FIG. 4C is an elevational view of the exemplary embodiment of FIG. 1A;

FIG. 4D is a bottom view of the the exemplary embodiment of FIG. 1A;

FIG. 4E is an elevational view of the exemplary embodiment of FIG. 1A; and

FIG. 4F is a side view of the exemplary embodiment of FIG. 1D.

### DETAILED DESCRIPTION

The vent/venting assembly of the present invention is capable of use in a roof or sidewall of a substantially enclosed structure, such as a building, trailer, or vehicle. Reference herein is made to vent or venting assembly interchangeably. While the invention is capable of use and installation in the top, roof, side, or wall of such a structure, the exemplary embodiment described relates to installation of the venting assembly in the roof of a recreational vehicle. The present invention is not limited to this exemplary embodiment and is only limited by the claims.

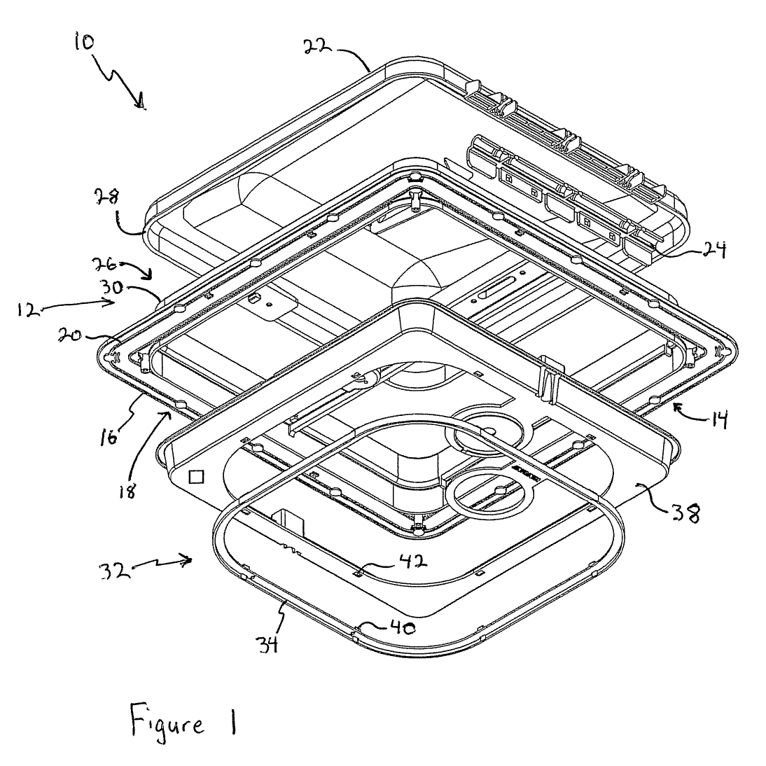

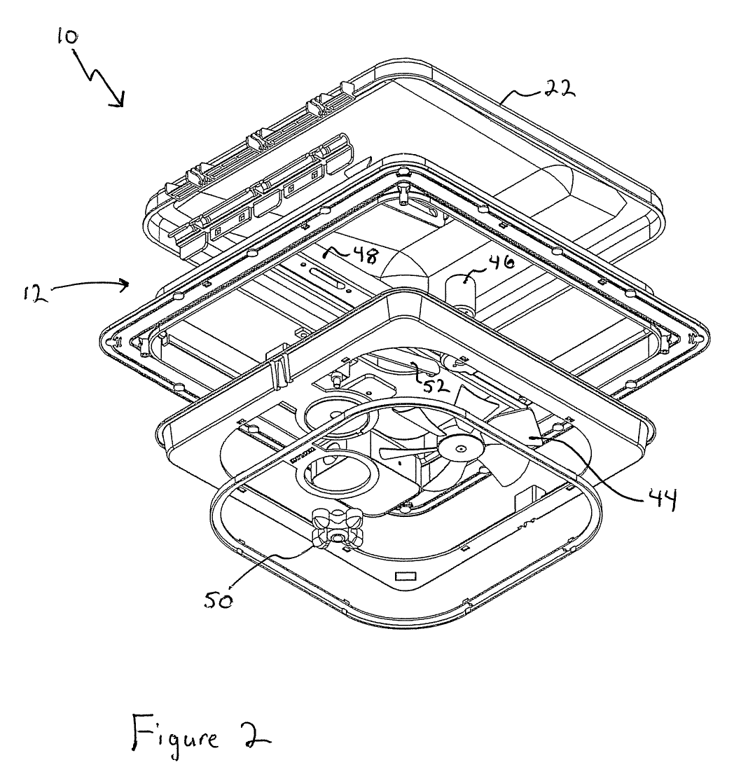

FIG. 1 illustrates an exemplary embodiment of a venting assembly 10 for use in a roof of a recreational vehicle. This venting assembly 10 may be used for static ventilation or be equipped with a powered fan for inducing airflow, as illustrated in FIG. 2. The venting assembly 10 also may be equipped with a screen that allows the passage of air yet prevents the entry of insects, as described below.

The venting assembly 10 illustrated in FIG. 1 includes a frame 12 to install in the top, roof, side, wall, or the like of the desired structure. Illustrative examples are shown in the Figures. The frame 12 fits into a hole in the structure, or a hole is cut into the structure into which the frame 12 will fit. The frame 12 and the hole may be of any geometric configuration, such as rectangular, circular, or any other shape.

The frame 12 includes a periphery 14 and a flange portion 16 that extends radially outwardly from the frame periphery 14. The flange 16 contacts the surface of the structure and provides a surface with contact points with the structure to enable fixation of the venting assembly to the structure.

There is an open area 18 of the frame disposed radially inwardly of the periphery 14. After the frame 12 has been installed in the structure, air may pass through the open area 18 of the frame 12 and between areas inside the structure and outside the structure. When the venting assembly 10 is installed in the structure, the contact between flange 16 and the structure assists in prevention of the flow of air between inside and outside areas around the periphery 14 of the frame.

In one embodiment, there is a first flange seal 20 associated with the flange 16 that assists in providing a seal between the frame 12 and the structure. The first flange seal 20 snaps into place onto the underside of the flange 16, or may be attached to the flange 16 with adhesive, or may be secured in any other manner without departing from the spirit and scope of the invention. In one embodiment, the first flange seal 20 is provided on the flange 16 by the vent manufacturer before the venting assembly 10 is provided to the installer, such as a recreational vehicle manufacturer. The flange seal 20 also can be, for example, integral with the flange 16.

The frame 12 may also be fitted with a garnish (not shown) extending into the structure. The garnish extends downwardly from the frame into the interior of the recreational vehicle to provide an aesthetic cover for portions of the venting assembly that would otherwise be visible from the interior of the recreational vehicle.

In one embodiment, the venting assembly 10 includes a manual or powered operable cover 22 allowing the vent 10 to open to the atmosphere. When closed, this cover 22 inhibits the passage of air between the areas inside the structure and outside the structure. The cover 22 is attached via a hinge 24 to the structure or to the frame 12 or in any manner to enable the cover 22 to be moved, or opened, such that air may pass between the areas inside and outside the structure. In one embodiment, the cover 22 is translucent to allow for the passage of light.

The hinge 24 may be a separate hinge 24, as illustrated in FIG. 1, or the hinge 24 may be part of the cover 22 or the frame 12. The hinge 24 is fixable to the cover 22 or the frame 12, or both, via a snap fit without external fasteners.

A second seal 26 may also be provided between the cover 22 and the flange 16 or frame 12. In one embodiment, this second seal 26 is integral with the frame 12 or the flange 16. The second seal 26 may be snapped in place, or may be attached to the frame 12 or the flange 16 with adhesive, or may be secured in any other manner without departing from the spirit and scope of the invention. In one embodiment, the second seal 26 is provided on the flange 16 by the vent manufacturer before the venting assembly 10 is provided to the installer, such as a recreational vehicle manufacturer.

In one embodiment, the second seal 26 includes a cover feature 28 such as a lip, groove, or the like molded into the cover 22 and a frame or flange feature 30 such as a groove, lip, or the like molded into the flange 16 or frame 12. When the cover 22 is closed, the cover feature 28 cooperates with the frame or flange feature 30 to create a seal, such as a labyrinth seal, between the cover 22 and the frame 12 or flange 16. This eliminates the need for an elastomeric seal or gasket that is necessary in most conventional venting assemblies.

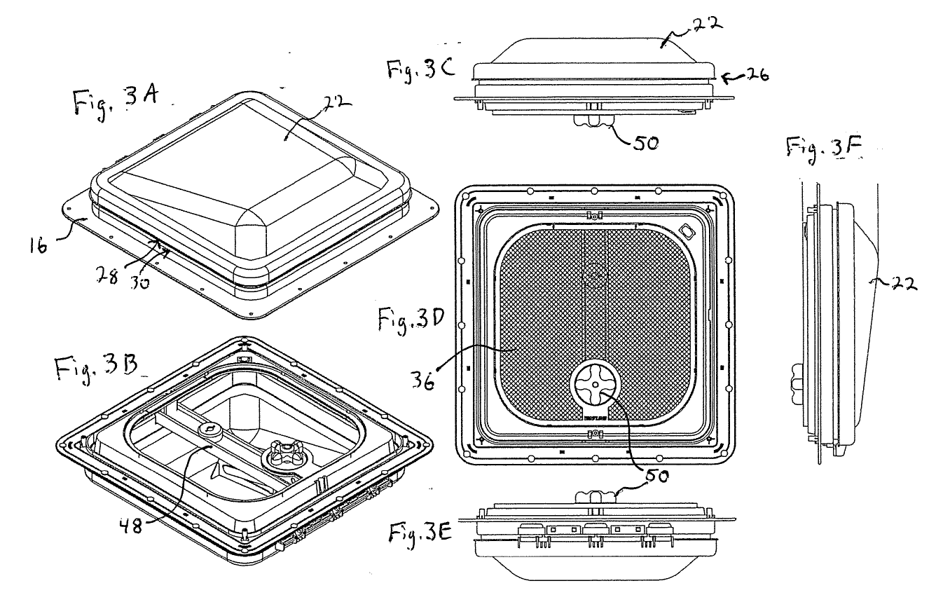

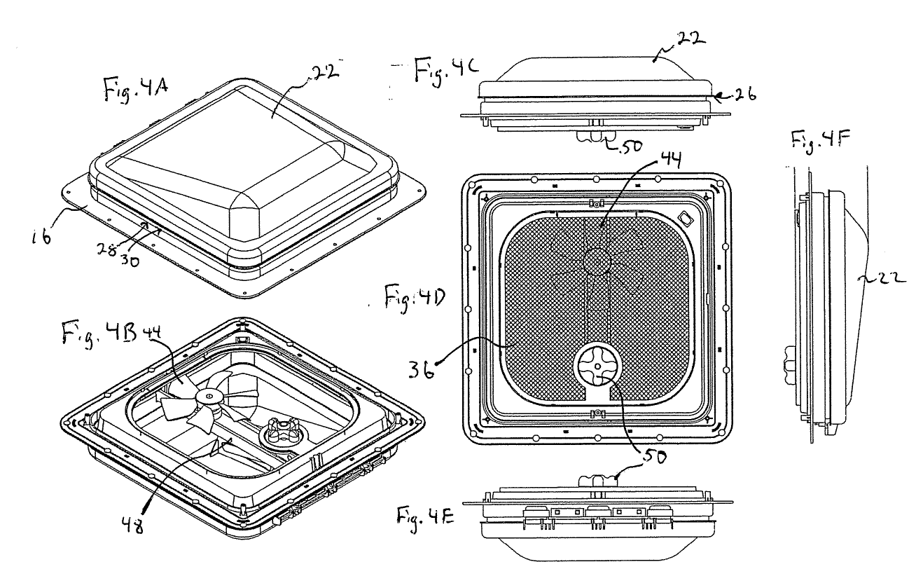

The venting assembly 10 includes, for example, a removable screen 32 to prevent undesirable elements, such as insects, from entering into the structure through the venting assembly 10. The screen 32 may be removed, such as for cleaning, and replaced in the vent. In one embodiment, the screen 32 includes a screen frame 34 around the periphery of the screen 32 and a mesh portion 36, illustrated in FIGS. 3A through 4F, that is secured by the screen frame 34. The screen frame 34 snaps into a screen frame housing 38, which, in turn, snaps into the frame 12. Male features 40 along the screen frame 34 snap into female features 42 of the screen frame housing 38, but the male/female features may be reversed without departing from the spirit and scope of the invention.

FIG. 2 illustrates a venting assembly 10 having a fan 44 and a motor 46 to drive the fan 44. In one embodiment, the motor 46 is attached to a mounting bar 48 by snap fit. In other embodiments, the motor 46 is attached to the mounting bar 48 by conventional attachments, such as nuts/bolts, screws, pins, etc. The mounting bar 48 is attached to the frame 12, such as by snap fit. The mounting bar 48 may also be integral with the frame 12, for example.

The motor 46 is operatively connected to the fan 44 to drive the fan 44 at a plurality of speeds. A user may control the fan 44 and the motor 46 via a switch and circuitry not shown.

FIGS. 3A through 3F illustrate an embodiment in which there is no fan 44 present. FIGS. 4A through 4F illustrate an embodiment in which there is a fan 44 present.

In one embodiment, the cover 22 is manually operated. For example, as illustrated in FIGS. 2, 3, and 4, a manual lift knob 50 connects to a geared operator or other mechanical apparatus 52 connected to the cover 22 that serves to engage and raise or lower the cover 22 in response to turning the manual lift knob 50. In other embodiments, the cover 22 is electrically powered. In one embodiment, the cover 22 automatically opens if a fan 44 in the venting assembly 10 is started. In one embodiment, the closing the cover 22 will automatically shut off the fan 44.

The cover 22 is structured aerodynamically, for example, to reduce interference with air flow over and around the cover 22. The cover 22 is made, for example, from a translucent resin, to allow light to enter the structure. The specific translucent resin may be selected depending on the circumstances and parameters of the installation without departing from the spirit and scope of the invention.

In one embodiment, the venting assembly 10 is constructed primarily of molded plastic resin. For example, the frame 12, cover 22, screen frame 34, screen frame housing 38, fan 44, garnish (not shown), manual lift knob 50, motor/operator mounting bar 48, hinge 24, and flange 16 are made primarily of molded plastic.

The molded parts are configured such that portions of the venting assembly 10 that are conventionally multi-part assemblies, for example the frame 12 or the cover 22, are produced as one-piece integrated components. The frame 12 with flange 16 and operator/motor mounting bar 48 are, for example, molded as a single part to reduce the number of separate components. The molded components are capable of being joined by snap fits or are integrally joined, instead of fastened by conventional mechanical fasteners, for assembling the molded parts together. For example, some of the modular components are fitted with male feature and some are fitted with corresponding female features such that the male and female features cooperate to provide for a snap fit. By snap fits, it is meant that the pieces are capable of being joined together without external fasteners, such as by a frictional fit. For example, the cover may be attached to the frame by a snap fitting, instead of by other mechanical fasteners.

Enabling the components to be secured or fastened by snap fitting allows the assembly time to be reduced. Also, use of the snap fittings enables the end user to more easily replace or upgrade components. The modular construction enables like components to be readily interchangeable between venting assemblies. Because of this modular construction and snap fitting of parts, multiple configurations of the venting assembly may be made in the field by the layman.

For example, if the venting assembly is installed without an electric fan, a fan and motor may be installed by snapping the fan blade into place in the venting assembly and the motor onto the operator/motor mounting bar. An electrical junction box may be snapped into place on the frame/flange, and appropriate connections made between the electrical junction box, the motor, and the fan blade.

If the end user desires to replace or upgrade components, the modular design enables each component to be individually replaced without replacing the entire venting assembly. For example, a new cover may snapped into place to replace the old cover. An electric fan may be installed, as described above. The screen can be replaced, for example, if it develops holes. These components can be snapped into place without necessitating more complicated fastening mechanisms to unfasten and refasten.

In one embodiment, at least half of the separable components of the venting assembly are capable of being attached to at least one adjacent component without the use of external fasteners, such as by snap fit. For example, all of the separable components are capable of attachment by snap fit. Alternatively, substantially all of the separable components are capable of attachment by snap fit, such as greater than 75% of the components. As described above, the snap fit may be accomplished by cooperating male and female features distributed on adjacent components. Not all components need have these features and may be connected by snap fit via other features, such as tongue-in-groove or other configurations that allow for snap fitting. The modular components may all have the same type of snap fitting features or may have a mixture of these features.

Also, many of the parts of the venting assembly are constructed from molded plastic, instead from heavier materials, such as steel. This results in a venting assembly with less weight than conventional venting assemblies, making it even easier for the end user to change or add components, as well as providing other benefits associated with reduced weight.

The user determines whether the venting assembly is to be installed into the structure with screws or with clamps. In one embodiment, the vent is installed with an electric fan designed to evacuate air out of the structure, provide air into the structure, or capable of moving air in either direction (reversible). The fan may be a single- or multiple-speed fan. In other embodiments, the vent is not provided with an electric fan. Illustrative examples including a fan are shown in FIGS. 2 and 4.

While the present invention has been illustrated by the above description of embodiments, and while the embodiments have been described in some detail, it is not the intention of the applicants to restrict or in any way limit the scope of the invention to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departing from the spirit or scope of the applicants' general or inventive concept.

We claim:

1. A venting assembly arranged to vent a substantially enclosed structure, the assembly comprising a plurality of modular components, substantially all of the modular components capable of engagement with an adjacent modular component by snap fit, enabling the modular components to be attached to and detached from each other without the use of external fastening elements and enabling individual modular components to be replaced or added into the assembly without replacing adjacent components.

2. The venting assembly of claim 1, wherein at least one of the modular components comprises at least one integral male feature or at least one integral female feature, capable of engagement with a corresponding female feature or male feature of an adjacent modular component.

3. The venting assembly of claim 1, wherein the substantially enclosed structure is a vehicle.

4. The venting assembly of claim 3, wherein the vehicle is a recreational vehicle.

5. The venting assembly of claim 3, wherein the vehicle is a boat.

6. The venting assembly of claim 1, wherein the substantially enclosed structure is a trailer.

7. The venting assembly of claim 1, wherein the modular components are selected from the group consisting of one or more of a frame, a seal, a cover, a garnish, and a screen.

8. The venting assembly of claim 1, further comprising a junction box, fan motor, and fan blade.

9. A vent for use with a structure having a top and at least one side, the vent comprising a plurality of modular components, at least one modular component comprising at least one integral male feature or at least one integral female feature, wherein the feature is capable of engagement with a corresponding female feature or male feature of an adjacent modular component, enabling the modular components to be attached and detached to each other without the use of external fasteners.

10. The vent of claim 9, wherein the modular components are selected from the group consisting of one or more of a frame, seal, cover, screen, junction box, and fan blade.

11. The vent of claim 9, wherein the vent is installed in the top of the structure.

12. The vent of claim 9, wherein the structure is selected from the group consisting of building, trailer, and vehicle.

13. A venting assembly for use with a recreational vehicle, comprising:
a) a frame for installation in the top of the vehicle, the frame having a periphery and an open area radially inwardly of the periphery;
b) a flange extending peripherally outwardly from the frame and capable of contacting the top of the vehicle;
c) a flange seal capable of establishing a seal between the flange and the top of the vehicle;
d) a cover hingedly attached to the frame by snap fit and capable of covering the open area of the frame to substantially prevent flow of air through the open area and further capable of being displaced to uncover the open area of the frame to allow flow of air through the open area; and
e) a removable screen connected to the frame and substantially covering the open area, the screen comprising:
i) a screen frame housing capable of engaging the frame via a snap fit without external fastening elements;
ii) a screen frame capable of engaging the screen frame housing by snap fit without external fastening elements; and
iii) a mesh portion secured by the screen frame;
wherein the frame, the flange, the cover, the screen frame housing, and the screen frame are constructed primarily of molded plastic.

14. The venting assembly of claim 13, further comprising a fan assembly comprising a fan blade and a fan motor.

15. The venting assembly of claim 13, wherein the flange seal is integral with the flange.
